(19) United States
(12) Patent Application Publication
(10) Pub. No.: US 2014/0369474 A1
(43) Pub. Date: Dec. 18, 2014

(54) X-RAY GENERATION DEVICES AND METHODS

(71) Applicant: Chiral Research, Inc., Tucson, AZ (US)

(72) Inventors: Francis Anthony Nottke, Tucson, AZ (US); Randolph Edward Seligmann, Tucson, AZ (US)

(21) Appl. No.: 14/302,575

(22) Filed: Jun. 12, 2014

Related U.S. Application Data
(60) Provisional application No. 61/834,380, filed on Jun. 12, 2013.
(60) Provisional application No. 61/992,059, filed on May 12, 2014.

(51) Int. Cl. H05G 2/00

(52) U.S. Cl. CPC H05G 2/00
USPC 378/119

(57) ABSTRACT

The present disclosure describes an x-ray generating device comprising at least one pair of rotating objects kept in constant frictional contact. In various embodiments, a first rotating object comprises an outer surface material with RDP of ∈₁, a second rotating object comprises a second outer surface material with RDP of ∈₂, ∈₁ does not equal ∈₂ and Δ∈ may be maximized by material selection, wherein the rotating objects are positioned in close proximity such that their first and second outer surface materials are kept in constant frictional contact, and wherein x-ray radiation is generated during rotation of the objects.

### CROSS REFERENCE TO RELATED APPLICATIONS

This application claims priority to U.S. Provisional Patent Application Ser. No. 61/834,380 filed Jun. 12, 2013, and to U.S. Provisional Patent Application Ser. No. 61/992,059 filed May 12, 2014, the entire contents of which are incorporated herein by reference.

### FIELD OF THE INVENTION

The present disclosure relates generally to radiation sources and in particular to a mechanical x-ray generating device.

### BACKGROUND OF THE INVENTION

X-rays have been known and used since the days of Roentgen in 1900. However, most conventional x-ray sources involve the use of heavy, large tubes which consume large amounts of power and require substantial cooling by water, air, or oil. The tubes typically only convert less than 10% of the total power applied, leading to a substantial loss of energy.

Conventional x-ray photons are generated in events involving electrons and are one form of ionizing electromagnetic radiation used in medical radiography. This radiation is much more energetic than everyday radiation types such as radio waves and visible light. Proper production and detection of photons are important in a wide variety of fields: security, safety, medicine, non-destructive testing, etc. X-ray radiation for medicine and medical imaging is typically produced by x-ray tubes, which operate through bombarding the anode with high energy electrons emitted from the (hot) cathode. Image sharpness, contrast, and patient dosage are important considerations in medical radiography and these requirements determine the desired energies of the tube, the type of material used on the anode, and the method in which the power is generated to drive the tube. FIG. 8 is a table having examples of current x-ray technology applications and corresponding characteristics, such as accelerating potential, source type, target material, and average photon energy.

Although the technical definition of x-rays ranges from 1-700 keV, x-rays used in medicine typically are in the range of 5-150 keV. The photons emitted come in discrete bands of energy corresponding to the atomic number of the anode, and the undesired bands are filtered out. The choice of the anode metal and its emitted radiation energies depends on the application and the tissue type. For example, molybdenum is often used in mammography because of its 20 keV x-rays. Radiation energy that is too high will result in poor imaging since the radiation cannot be readily attenuated; radiation energy that is too low will increase the radiation dosage of the patient without improvements in image quality.

Further, sharpness in radiographic imaging is usually determined by the size of the x-ray source, which is determined by the total area of the electron beam hitting the anode. Too large a photon source results in more blurring in the final image and is worsened by an increase in image formation distance. This blurring is measured as the contribution to the modulation transfer function of the imaging system.

Power required to run conventional x-ray tubes is generated by specialized generators, which supply the voltage and current required to drive the tube. The specialized generator needs to supply high voltages with small exposure time, which is described by two variables. The first variable is the peak voltage of the cathode to anode, and the second variable is the milliamp seconds of exposure time. The two variables are controlled by an x-ray machine operator but can be assigned by the x-ray machinery by sampling the emitted radiation. Power generators usually convert standard 120 or 220 volt AC to higher DC voltages.

With these limitations of conventional x-ray sources in mind, it is clear that new x-ray devices need to be developed having low energy input requirements and low operating temperature, and which are affordable, recyclable, lightweight, compact and portable, easy to reconfigure, and incapable of emitting residual radiation.

### SUMMARY OF THE INVENTION

In various embodiments of the present disclosure, an x-ray device having a variety of benefits in comparison to prior x-ray source technology is disclosed. Some of these benefits include, for example, low energy input requirements, low operating temperature, such as to eliminate need for cooling, affordability and recyclability, portability due to compact size, ease in reconfiguring, no residual radiation, and lightweight structure. Unlike conventional x-ray sources, in various embodiments the disclosed x-ray device is mechanical and does not use or contain high voltages, high temperatures, cooling systems, radioactive materials, any thermoelectric, pyro-electric, or piezoelectric mechanisms, electronics, or extra electrical apparatuses.

Moreover, various embodiments of the present x-ray device, although generating x-rays from triboelectric effects, do not contain adhesive tape, or require any peeling and detaching of adhesive, epoxy, film, or tape from a substrate in order to function. Although various embodiments can comprise adhesive or resin material, other embodiments of the present device can operate without either adhesive or resin materials. Without requiring the pulling apart of adhesive and substrate layers, the x-ray device in accordance with the present disclosure has the distinct advantage that it will not emit x-rays only in pulses, because in the inventive design disclosed herein there cannot be slips in force from the peeling of an adhesive tape, which cause the pulses. In addition, the present inventive x-ray device can operate without the use of any piezoelectric components, including accentuators. X-ray devices in accordance with the present disclosure also do not include any piezoelectric materials.

In accordance with various embodiments, an x-ray device comprises a first rotating object having a first outer surface material, and a second rotating object having a second outer surface material, wherein the first rotating object and the second rotating object are disposed in close proximity such that the first and second outer surface materials are kept in constant frictional contact during rotation, wherein x-ray radiation is generated from the rotation.

In various embodiments, the frictional force between the outer surfaces of the first rotating object and the second rotating object is adjusted through relative positioning such that a desired size surface area of contact and friction is achieved and maintained during rotation of the first and second objects.

In various embodiments, the first outer surface material has a dielectric constant ∈₁ and the second outer surface material has a dielectric constant ∈₂, wherein ∈₁ does not equal ∈₂. In various embodiments, the difference between ∈₁ and ∈₂ (herein Δ∈ is maximized by selection of the first and second outer surface materials.

In various embodiments, the first rotating object is constructed of a single material throughout such that the inner material is identical to the said first outer surface material. In various embodiments, the first rotating object is constructed of more than one material such that the first outer surface material may differ from any one of the various inner materials. In various embodiments, the first rotating object is coated or wrapped with a substance that provides the first outer surface material.

In various embodiments, the second rotating object is constructed of a single material throughout such that the inner material is identical to the said second outer surface material. In various embodiments, the second rotating object is constructed of more than one material such that the second outer surface material may differ from any one of the various inner materials. In various embodiments, the second rotating object is coated or wrapped with a substance that provides the second outer surface material.

In various embodiments, either or both of the first and second outer surface materials is/are provided by at least one continuous belt pulled between and out through the rotating first and second objects in a continuous fashion.

In various embodiments, the first rotating object and the second rotating object are disposed within a vacuum environment.

In various embodiments, the first rotating object is rotated in a first direction to cause the second rotating object to rotate in an opposite direction of the first direction. In various embodiments, both the first rotating object and the second rotating object are mechanically driven by drive shafts rotating in opposite directions.

In various embodiments, radiation energy, such as x-ray radiation, is continuously generated without noticeable slip/stick pulsing in response to the rotating first and second objects in constant contact.

In various embodiments, a method of generating x-ray radiation is disclosed, with the method comprising: positioning a first rotating object and a second rotating object in constant frictional contact, wherein x-rays are generated in response to the rotating of the first and second rotating objects.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure, wherein:

FIG. 1 shows a relationship between various types of luminescence;

FIG. 2 shows a table of a triboelectric series;

FIG. 3 illustrates an x-ray device in accordance with various embodiments of the present disclosure;

FIGS. 4A-4E illustrate various rotating object shapes in accordance with various embodiments of the present disclosure;

FIG. 5 illustrates various surface configurations in accordance with various embodiments of the present disclosure;

FIG. 6 illustrates an exemplary radiation output from an embodiment of multiple rotating objects in accordance with the present disclosure;

FIG. 7 illustrates an exemplary multiple rotating object embodiment in accordance with the present disclosure;

FIG. 8 is a table of current x-ray technologies and their corresponding characteristics; and

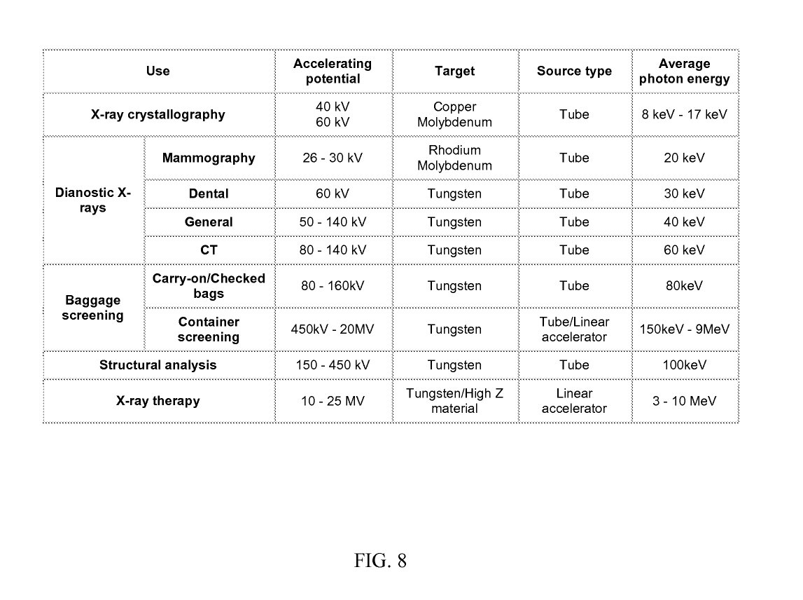

FIG. 9 illustrates electromagnetic focusing of x-ray radiation in accordance with various embodiments of the present disclosure.

### DETAILED DESCRIPTION OF THE INVENTION

While exemplary embodiments are described herein in sufficient detail to enable those skilled in the art to practice the invention, it should be understood that other embodiments may be realized and that logical structural, material, and mechanical changes may be made without departing from the spirit and scope of the invention. Thus, the following detailed description is presented for purposes of illustration only.

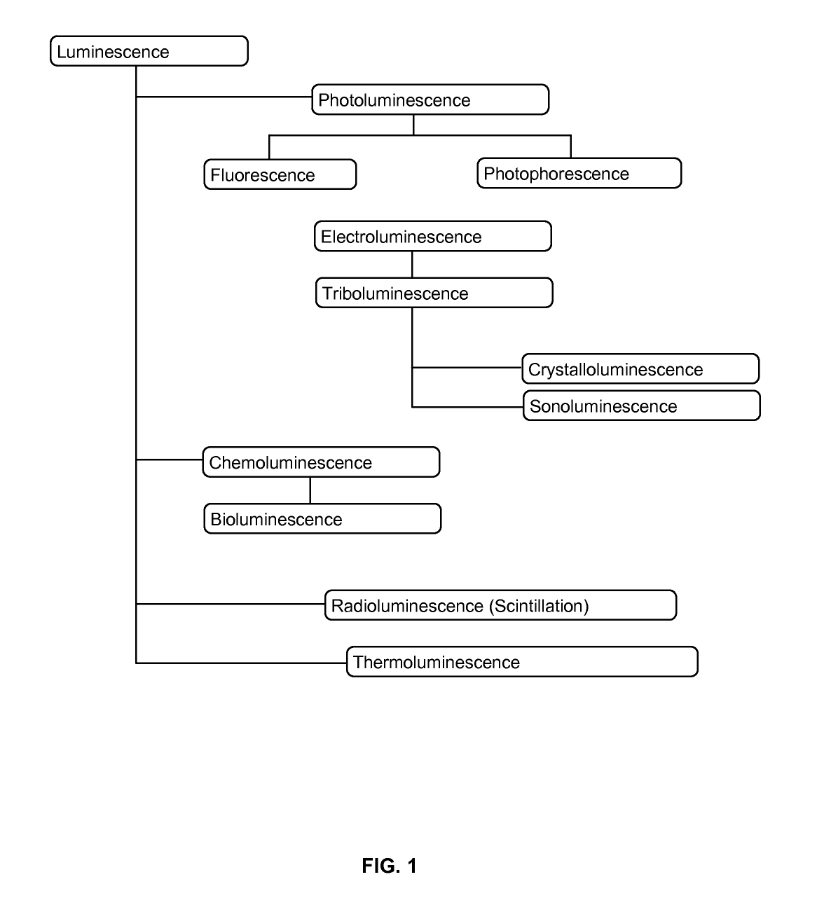

Electricity comes from the Greek word for amber-electron (ηλ∈κτρον). The Greek prefix ‘tribo’ means rubbing or friction. The triboelectric phenomenon from friction rubbing or impact is seen throughout history and in a variety of fields. The Greeks first characterized this to assist their basic understanding of atoms. “Electroluminescence” is a Luminescence excited in gases and solids by applying an electromagnetic field (see FIG. 1). Molecules are excited upon creation of any form of electric discharge in a material. Electroluminescence of gases is used in discharge tubes. The electroluminescence effect, which readily occurs in semiconductors and light emitting diodes (LEDs), is the most well-known application. As another example, natural blue diamond emits light when electrical current is passed through it.

The “tribo” phenomena is seen in many areas of science and engineering, including photographic production, powder handling, electrical production, x-ray creation, electrostatic discharge (ESD), lightning and geology. Possible mechanisms for these phenomena have been postulated since the time of the Greeks. Published papers have attempted to elucidate the phenomena based on considerations from plasma theory, friction, adhesion, contact electrification, pyroelectricity, and charge imbalance. While various causes explain certain elements of tribo phenomena, no satisfactory mechanism has emerged covering the phenomena in general. Scientists need to determine the defining relation which demonstrates understanding of all the areas of tribo phenomena. While the mechanism of charge transfer has been invoked to qualitatively explain tribo phenomena, as has plasma theory, here we believe the fundamental defining relation applicable to all tribo phenomena is the difference between the Relative Dielectric Permittivity (RDP, or dielectric constant) values ∈₁ and ∈₂ for two interacting materials. We also believe that the Relative Dielectric Permittivity ∈ is a more influential factor in many chemical and physical phenomena than previously realized. Many fundamental equations and interactions depend critically on the differences in Relative Dielectric Permittivity ∈ of the materials to determine their outcome.

“Triboluminescence” occurs when a material is scratched, crushed, rubbed or stressed mechanically in any way. When a material is subjected to mechanical stress and spatially separated, electrical charges are produced. Upon recombining these charges, a flash of light emerges as a result of electric discharge, ionizing the surrounding space. Since electrical discharge is in the foundation of triboluminescence, it can be classified as a part of electroluminescence. For example, blue or red triboluminescence can be observed when sawing a diamond during the cutting process. Another example includes sugar crystals, which produce tiny electrical sparks while crushing. Other substances exhibiting triboluminescence include minerals fluorite (CaF₂) and sphalerite (ZnS).

The process of electron transfer as a result of two objects coming into contact with each other and then separating is known as ‘triboelectric charging’. The process of triboelectric charging results in one object gaining electrons on its surface, and therefore becoming negatively charged, and another object losing electrons from its surface, and therefore becoming positively charged. The specific phenomenon of charge separation by rubbing is called triboelectricity. In U.S. Application Publication No. 2013/0049531, Wang et al. disclose an electric current and voltage generator comprising first and second textured surfaces that are repeatedly placed in contact and separated.

The process of becoming charged by rubbing is known as triboelectrification. The electrical charge produced by friction between two objects that are nonconductive is triboelectricity. Rubbing glass with fur, or a comb through the hair, can build up triboelectricity. Most everyday static electricity is triboelectric in nature.

Electrostatic discharge (ESD), which is the rapid transfer of electrostatic charge between two objects that can result in damage to semiconductor devices, arises from charge build-up that occurs as a result of an imbalance of electrons on the surface of a material. A common semiconductor industry definition states ESD is a single-event, rapid transfer of electrostatic charge between two objects, usually resulting when two objects at different potentials come into direct contact with each other. This effect is one of the oldest observed phenomenon (as lightning) in history. Such a charge build-up develops an electric field that has measurable effects on other objects at a distance.

Of two interacting materials, which material becomes negative versus which becomes positive depends on the relative tendencies of the materials to gain or lose electrons. Some materials have a greater tendency to gain electrons than most others, in the same way that there are others which tend to lose electrons easier than others.

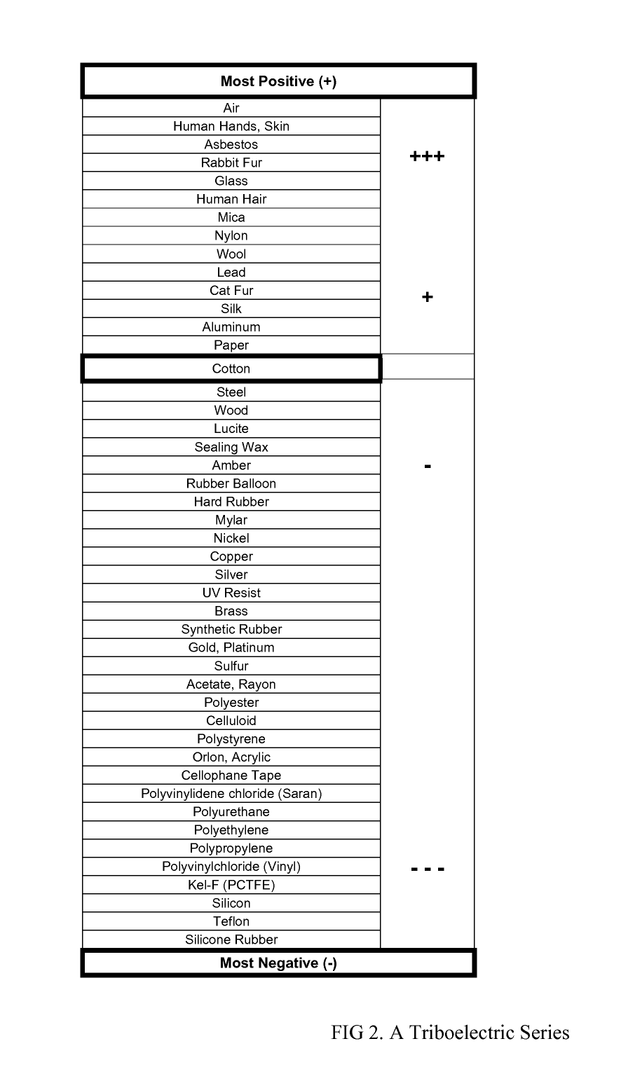

A triboelectric series (e.g. as the one shown in FIG. 2) is a list that ranks various materials according to their tendency to gain or lose electrons. It usually lists materials in order of decreasing tendency to charge positively (lose electrons), and increasing tendency to charge negatively (gain electrons). Somewhere in the middle of the list are materials that do not show strong tendency to behave either way. Note that the tendency of a material to become positive or negative after triboelectric charging has nothing to do with the level of conductivity (or ability to discharge) of the material.

Different researchers sometimes get different results in determining the rank of a material in the triboelectric series. One of the reasons for this is the multitude of factors and conditions that affect a material's tendency to charge. The triboelectric series here is a product of the collation of several widely-used triboelectric series published on the web.

Triboluminescence can result from friction, such as from the peeling of adhesive tape, breaking rock sugar or other crystals with a hammer, peeling mica layers, and the like. In recent years, devices producing triboluminescence in vacuum conditions have been tested and found to generate x-ray radiation. For example, in U.S. Pat. No. 8,699,666, Putterman et al. disclose an automatic adhesive tape peeling machine set up like a reel-to-reel tape recorder that peels adhesive tape in a vacuum environment. Although such a device does produce x-ray radiation, the radiation produced is inherently generated in pulses, because of slip/stick frictional effects inherent when peeling an adhesive layer from a substrate, regardless that the peeling is mechanized and not manual. Another minor drawback of such a device is the inability to produce x-rays continuously since the adhesive tape roll is of fixed length and will eventually run out.

Extensive research is underway in many countries to utilize triboelectricity. One significant application for tribomechanics is for a source of x-rays capable of exciting the characteristic emission lines of medically or scientifically useful metals (Mo, Ag, Cd, W, etc), as is disclosed by various embodiments herein. Further, as described herein, in various embodiments, a device can use the triboelectric effect to produce a charge imbalance in response to a rotating object and a triboelectrically opposite rotating object (either of which may be loaded with a particularly chosen metal or metal oxide) rolling against each other in vacuum chamber. The exemplary device may operate without cooling, have a low mass structure, and/or without internal or external high voltage supply. The exemplary device can supply a source of high keV electrons which creates bremsstrahlung and characteristic x-rays.

Modern industrial processes using tribo phenomena include photographic reproduction, laser printer toners, powder handling, and paint/metal powder application. Tribo phenomenon can also be highly destructive and dangerous (e.g. grain silo explosions).

Modern experiments in triboelectric phenomena date from the late 1880s from electrokinetics. Remarkably, German scientist Alfred Coehn (1898) was the first to discover and classify a scale of electrokinetic interaction based on differences in relative permittivity between two interacting materials. This went unnoticed by all major tribo researchers until now.

Shaw (1917-1929) created/ordered the largest lists of tribo material tendencies. Shaw's lists were remarkable in their depth and variety, and used distinctions between various states of matter: water versus oily for liquids, and solid blocks versus solid diaphanous materials. Shaw did not classify beyond sorting the list from positive to negative.

Harvey (1939) was the first to observe light emission from peeling tape, but lacking an x-ray detector he was unable to see the x-ray phenomenon present. While not the first to discover tribo phenomena, Putterman, Hird, and Camara, were the first to accurately characterize the high energy non-linear concentration and emission processes involved in tribo interactions. They were also the first to attempt to harness this phenomenon for x-ray production; others to attempt this included Stocker and Constable. Triboelectric generation for power has been the subject of intense research at Georgia Tech and in China using structured sheets/shapes of materials of different permittivity.

All papers attempting to explain tribo phenomena invoke all or parts of four possible mechanisms: (1) charge imbalance/separation via contact electrification; (2) electron/ion creation and emission; (3) piezo- and pyro-electricity; and (4) soft (or opaque) plasma theory.

Role of Relative Dielectric Permittivity in Physics and Chemistry

The Relative Dielectric Permittivity (RDP)—sometimes called the dielectric constant, and designated by the Greek letter ∈—measures of the capability of a substance to store charge from an applied electromagnetic field, and transmit that energy. It is also defined as the ratio of a material's electrical permittivity to the vacuum electrical permittivity. Chemists discuss this as the extent of a material's ability to insulate charges from another, and in solvent theory, whereby a larger value of ∈ means a higher polarity.

RDP is considered a constant (as in static, zero-frequency relative permittivity) but is not a constant in all materials or conditions. It can vary with site in a material, frequency and strength of an applied electromagnetic field (especially for nonlinear media), humidity, temperature, etc. When permittivity is a function of frequency it may have real/complex values, and may be a tensor.

Substances may be described by their complex-valued permittivity (with real and imaginary parts; or as conductivity σ). Perfect conductors are considered to have infinite conductivity, and perfect dielectrics are considered to have no conductivity.

The significance of RDP can be seen from its role in the many and varied equations incorporating it: from the equation for the speed of light:

c²=1/∈₀μ₀ (1)

to the many forms of Maxwell's equations, such as the constitutive relations for linear materials:

D=∈E,H=1/μB (2)

(μ is permeability of the material), to the Clausius-Mossotti equation demonstrating the connection between the RDP and material properties (this formula is seen in the theory of conductivity as Maxwell Garnett equation, and in the theory of refractivity as the Lorentz-Lorenz equation):

∈−1/∈+1=N_{A}_{^{ρ}}_{·n}α/3M (3)

The Role of Relative Dielectric Permittivity in Triboelectric Generation

The RDP ∈ is the defining relation which governs the mechanism of tribo phenomena. This is seen by examining Van der Waals (VDW) potentials/forces between interacting surfaces. While understanding a high energy effect using a relatively low interaction potential like VDW theory is unusual, the steps to this are straightforward.

The interaction laws for various geometries involving the VDWs potential and force equations are given in terms of the Hamaker constant ‘A’. This constant has the units of energy (usually ergs or joules). Positive ‘A’ implies attraction (negative force) and a negative ‘A’ implies repulsion (positive force).

VDW interactions between surfaces of solid macroscopic objects can be measured from summing interaction and adhesion forces, both of which are calculated using the Hamaker constant ‘A’. See, for example, Israelachvili, J. N. Intermolecular and Surface Forces Third Edition (2011). At contact distance (between surfaces <1 nm), adhesive pressures can be up to several thousand atm, and the adhesion energy can be hundreds to thousands of milli-joules per square meter. This adhesion energy is actually the surface energy of a solid (in a liquid this is called surface tension). See, for example, Israelachvili, J. N. Intermolecular and Surface Forces Third Edition, Chapter 13, (2011).

The exact calculation of the Hamaker constant ‘A’ essential to demonstrate VDW surface energy requires, however, the more exact Lifshitz (quantum field) theory to account for the many interactions groups of atoms can experience, and is derived in terms of the bulk property of RDP. All expressions for interaction energies are the same, only the Hamaker constant ‘A’ is calculated differently in a more precise fashion. See, for example, Israelachvili, J. N. Intermolecular and Surface Forces Third Edition, 257 (2011).

Researchers simplified the complex Lifshitz method using the fact that VDW potentials are essentially electrostatic in nature, thus reducing this to an image charge problem. See for example Israelachvili, J. N. Intermolecular and Surface Forces Third Edition, 258 (2011). The result is an expression for ‘A’ that is entirely a function of the ∈₁, ∈₂, and ∈₃ for the three media (two interacting surfaces and the separating media), and accounts for VDWs, Keesom and Debye interactions, and dispersion energy. See, for example, Israelachvili, J. N. Intermolecular and Surface Forces Third Edition, Chapter 12, (2011). A number of rules and conditions can be derived from this exact calculation for ‘A’. See for example Israelachvili, J. N. Intermolecular and Surface Forces Third Edition, 251 (2011). Thus, the defining relation in VDW's is the Relative Dielectric Permittivity (RDP) ∈ of the material, specifically, the difference in RDP's ∈₁ and ∈₂ (herein Δ∈) between two interacting materials. The greater the difference in RDP values, the greater the triboelectric effect.

In various embodiments in accordance with the present disclosure, a first outer surface material and a second outer surface material positioned to interact are chosen such that ∈₁ does not equal ∈₂ (i.e., Δ∈ is not equal to 0). In various embodiments, a first outer surface material and a second outer surface material positioned to interact are chosen such that Δ∈ is maximized.

The purpose of TABLE 1 set out below is to demonstrate selection of various materials having different RDP values for interaction and the resulting triboelectric charge tendency possible during their interaction. For example, of two interacting materials, the first material may be chosen as polyester/epoxy whereby the second material may be chosen as silicone rubber/epoxy (optionally embedded with metal). In various other embodiments, opposing materials can be chosen from the group consisting of PDMA, PTFE, Kapton, epoxy, titanium dioxide, and aluminum in order to maximize Δ∈. In various other embodiments, opposing materials may be selected from the group consisting of epoxy, acrylic, Macor, quartz, and nylon in various combinations with metals, in order to maximize Δ∈. In various embodiments, materials as far apart as possible on the chart are chosen for interaction, (i.e. greater Δ∈).

TABLE 1
Tribo-electric Series Value Sorted from Positive to Negative with
Corresponding RDP Values Demonstrating Correlation.

| Triboelectric | | |
|---|---|---|
| Materials | Type | RDP (ε) |
| Acrylic | Polymer | 1.9 |
| Polyester | Polymer | 1.9 |
| Solid Paraffins | Hydrocarbon | 1.9 |
| Nylon 6,6 | Polymer | 2 |
| PTFE | Polymer | 2.1 |
| Polypropylene | Polymer | 2.2 |
| Polyethylene | Polymer | 2.3 |
| PDMS | Silicone polymer | 2.3 |
| Polyimide | Polymer | 2.8 |
| Lexan | Polymer | 2.96 |
| Anthracene | Mineral | 3.12 |
| Silicone Rubber | Polymer | 3.2 |
| Polycarbonate | Polymer | 3.2 |
| PVC | Polymer | 3.4 |
| PET | Polymer | 3.4 |
| Cellulose Acetate | Compound | 3.6 |
| Epoxy (Devcon | Adhesive | 3.6 |
| #14270) | | |
| Kapton | Polymer | 3.9 |
| Quartz SiO₂ | Non-metal oxide | 4.4 |
| Mica | Mineral | 4.5 |
| Macor | Glass | 5.5 |
| NaCl | Mineral | 6.1 |
| ZnO | Metal oxide | 8.6 |
| TiO₂ | Metal oxide | 50 |
| Molybdenum Mo | Metal element | / |
| Silver Ag | Metal element | / |
| Copper Cu | Metal element | / |
| Zinc Zn | Metal element | / |
| Tungsten W | Metal element | / |
| Lead Pb | Metal element | / |
| Aluminum Al | Metal element | / |
| Nickel Ni | Metal element | / |
| Gold Au | Metal element | / |

How RDP in VDW Theory Correlates with Tribo X-Ray Emission

Having established the importance of the RDP in the physical sciences, and its role as the defining relation in VDW's interactions, this then leads to examine how tribo phenomena can arise from a solid's surface energy γ—which is a function of ‘A’, which in turn is a function of the RDP's ∈₁ and ∈₂. Distinct from bulk energy, the total calculated surface energy γ is actually half the energy necessary to separate the two surfaces—thus, half the adhesion energy. See for example, Israelachvili, J. N. Intermolecular and Surface Forces Third Edition, Chapter 13, (2011); Israelachvili, J. N. Intermolecular and Surface Forces Third Edition, Chapter 12, (2011).

Surface energy values in millijoules per square meter vary: 10-40 for plastics and hydrocarbons, 750 for semiconductors (silicon), to thousands for metals (e.g., about 3000 for tungsten). Noting that 1 joule is 6.2415×10¹⁸ electron volts, it becomes apparent that even at millijoule values, the electron volt energy numbers will be high.

To see how the tribo effect from RDP physically manifests, consider an atomic surface in contact (collision) with another atomic surface. By examining atomic force microscope pictures and counting the number of atoms that project (known as asperities) from a surface, depending on orientation and border location, one sees approximately 200 atom asperities per 64 nm² area. See for example Giessibl, F., AFM's path to atomic resolution, Materials Today, 32-41, (2005). The asperities project about 200 pm (0.200 nm) from the surface; VDW forces control at approximately 10 nm, chemical exchange forces exert increasing influence at 0.1-1.0 nm, and repulsive forces dominate at 0.01-0.1 nm (about 10-100 pm, the exact size range of most atomic asperities).

About 200 atom asperities per 64 nm² area translates to about 3.125×10¹⁸ atomic projections per square meter, and taking the surface energy to be on the order of 1,000 mJ/m² (this is a mid-range value between plastics and metal, 6.2415×10¹⁸ electron volts/m²), thus 6.24150×10¹⁴ electron volts are available.

Taking the area of contact for most triboelectric experiments using peeling tapes (e.g. Putterman), contact rollers (as disclosed herein in accordance with the present disclosure), and surface accentuators (Putterman, Georgia Tech) is on the order of 10⁻⁴ square meters, this means that about 3.125×10¹⁴ atomic projections times two (two surfaces, 6.250×10¹⁴) are available to collide for x-ray emission—realistically, due to factors such as one projection pushing another aside, or a projection slipping between 2 projections, or uneven surfaces creating peaks and ridges, the actual number that will interact is one the order of 0.01% (10⁻⁴). Thus, available projections are on the order of 6.250×10¹⁰ and if 6.2415×10¹⁴ electron volts are available, then roughly the energy emitted per projection is 9.986×10³ eV (9.986 keV). The measured x-ray energies from most researchers (including these authors) are in the range of 10 keV.

More precise calculation of energy from VDW potentials and Lifshitz theory, and asperity number from surface structure that AFM (Atomic Force Microscope) data provides, for specific atomic and molecular materials, will allow for the prediction and creation of materials and devices for a wide variety of triboelectric generators and x-ray apparatus.

As variously described herein, various embodiments of the x-ray device in accordance with the present disclosure can generate triboelectricity as an economical, portable source of variable energy and intensity x-rays. The rate (number intensity) and photon energy (keV) emitted by the x-ray device can be variable and impacts the practicability and market value of this device.

In various embodiments, the x-ray device in accordance with various embodiments of the present disclosure can have variable brightness, also referred to as luminosity, which is defined as photons per second per square centimeter. Moreover, in various embodiments, the rate and photon energy can be variably selected by one or more of several methods, including: 1) escalating the velocity of the contact cycle by spinning the rotating objects faster, 2) increasing the area of contact by changing the compliance (pressure) between the rotating objects, 3) increasing the number of rotating objects, 4) increasing the size of the contact surface (larger rotating objects, belts, multiple rotating objects, etc.), 5) changing the composition of the rotating objects in accordance with the triboelectric series to be more positive or negative, 6) changing the composition of adhesive if used, 7) changing the metals embedded in either rotating object; or any combination of the seven previously mentioned methods.

Electromagnetic radiation in the x-ray range can be generated by the contact between interacting (e.g. rotating) objects in response to the friction. The x-rays generated by the interacting objects in contact can be focused as part of the production process. While the focusing may not increase photon flux, it can sharpen focus and increase photon energy due to increasing electron energy. The electromagnetic radiation originates at the friction point of the two interacting objects in contact and follows through from the friction point. For rotating objects in contact, the direction of the electromagnetic radiation is approximately tangent to both rotating objects, and orthogonal to a plane bisecting the axis of rotation of each of the two rotating objects.

In various embodiments, the x-ray device in accordance with the present disclosure has a variety of benefits in comparison to prior x-ray technologies. Some of these benefits include low energy input, low operating temperature so no cooling system needed, affordable, recyclable, portable due to compact size, easy to change, no residual radiation, and/or lightweight (depending on required output tube mass 1 to 10 kilograms).

Unlike conventional x-ray technology, in various embodiments the disclosed x-ray device is mechanical and does not use or contain high voltages, high temperatures, extra cooling ability, radioactive materials, any mechanism that is thermoelectric, pyro-electric, or piezoelectric, and no electronics or extra electrical apparatus.

Moreover, unlike other triboelectric devices disclosed in the prior art, the x-ray device in accordance with the present disclosure contains no adhesive tape, nor does it require any adhesive, epoxy, film, or tape layers to function. Although various embodiments can comprise adhesive or resin material as part of an outer surface of a rotating object, or on a moving belt, such as to help a continuously looped belt stay aligned on rollers, other embodiments can operate without either adhesive or resin materials anywhere in the device. In addition, the x-ray device in accordance to the present disclosure can operate without the use of piezoelectric components, including accentuators, and can be entirely devoid of any piezoelectric materials.

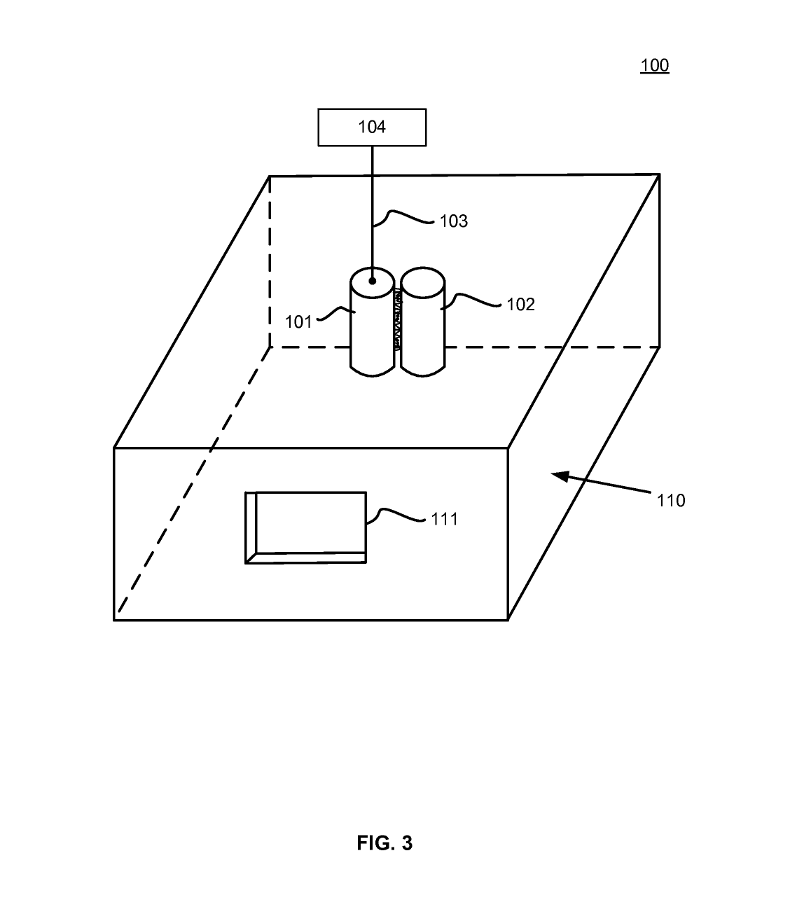

In accordance with various embodiments of the present device, and with reference now to FIG. 3, an embodiment of the x-ray device 100 comprises a first rotating object 101 rotating in a first direction, in contact with a second rotating object 102 rotating in a second direction opposite in direction to said first direction, and, optionally, a housing 110 surrounding the first and second rotating objects, such as to provide a controllable environment around the rotating objects. Although the rotating objects 101 and 102 exemplified in this embodiment are cylindrically shaped, any other practical shape for each of the two rotating objects are within the scope of the present disclosure, as discussed herein below. Furthermore, the shape of the first rotating object need not be identical to the shape of the second rotating object.

In various embodiments, the first rotating object 101 and/or the second rotating object 102 is/are rotated by a drive shaft 103 and a motor 104 driving the drive shaft 103. In various embodiments, only one rotating object is mechanically driven by a motor and drive shaft, while the other rotating object passively rotates due to its contact with the mechanically rotating object. In other embodiments, both the first and second rotating objects are driven in opposite directions by the appropriately configured motors and drive shafts. Although not illustrated, the relative position of each of the rotating objects is adjustable, for example to ensure constant contact and friction between the two rotating objects.

Optional housing 110 may further comprise window 111 made of any material substantially transmissive of x-rays. For example, window 111 may comprise glass, plastic, carbon, beryllium, and the like. Further, x-rays produced from the interacting objects 101 and 102 emanate through the window 111, and so are directed by the shape and position of the window. Housing 110 can be sealed to hold a vacuum. In various embodiments, the vacuum can be created and maintained by the motor 104. In other embodiments, a separate motor/pump is used to create and maintain a vacuum state in the housing 110. One of the benefits of a plastic housing in comparison to a metal housing is avoidance of any flux generation issues. In this way, all x-ray flux is generated by the rotating objects 101 and 102 in frictional contact, and not by any potential movement of the housing 110. The housing 110 can be a chamber, such as in a box or any other configuration. Housing 110 can be constructed of any natural, man-made or artificial material, so as to hold the rotating objects (in any shape or quantity), any possible electron focusing devices and any x-ray optics, in an enclosed space that can be held under vacuum. In various embodiments, the vacuum can be between room pressure and 10⁻⁶ torr. Housing 110 can be structured of any stable natural or manmade material such as metals, plastics, fibers, glass, ceramic, stone, or combination thereof, necessary to hold a vacuum of 10⁻² to 10⁻⁶ torr (depending on the intensity and purity of x-rays needed).

In various embodiments, x-ray device 100 comprises at least one drive shaft 103 that can be positioned through, and turn, the first rotating object 101. The second rotating object 102 is in contact with the first roller 101, such that when the first rotating object 101 is turned, the second rotating object 102 also turns, (or vice versa). The rotating objects 101, 102 turn in opposite directions, for example clockwise and counter-clockwise, thereby having continual friction generated at the plane of contact between the outer surfaces of the first and second rotating objects 101, 102. In various embodiments, the rotating objects 101, 102 can spin in the range of 10-1000 rpm to produce x-ray radiation. Furthermore, drive shaft 103 can be rotated by a motor 104 suitably configured and disposed. In one exemplary embodiment, motor 104 is located inside housing 110. In another embodiment, motor 104 is coupled to the housing 110, and connects to drive shaft 103 through housing 110. The coupled motor configuration can result in a more portable x-ray device. In various embodiments, motor 104 can be any device or apparatus that can impart rotational kinetic energy to the drive shaft or other object. Furthermore, for example, the motor 104 can be a belt, hand crank, or electric motor, such as one operating on either AC or DC power, or any other device as would be known to one skilled in the art.

In accordance with various embodiments, the different components of the x-ray device, namely the drive shaft and housing, can be made of plastic. Having plastic components enables a clean electromagnetic radiation generation since only the rotating objects would thus be capable of x-ray generation. The remaining components are plastic and not capable of generating electromagnetic radiation that could cause contamination of the resulting flux.

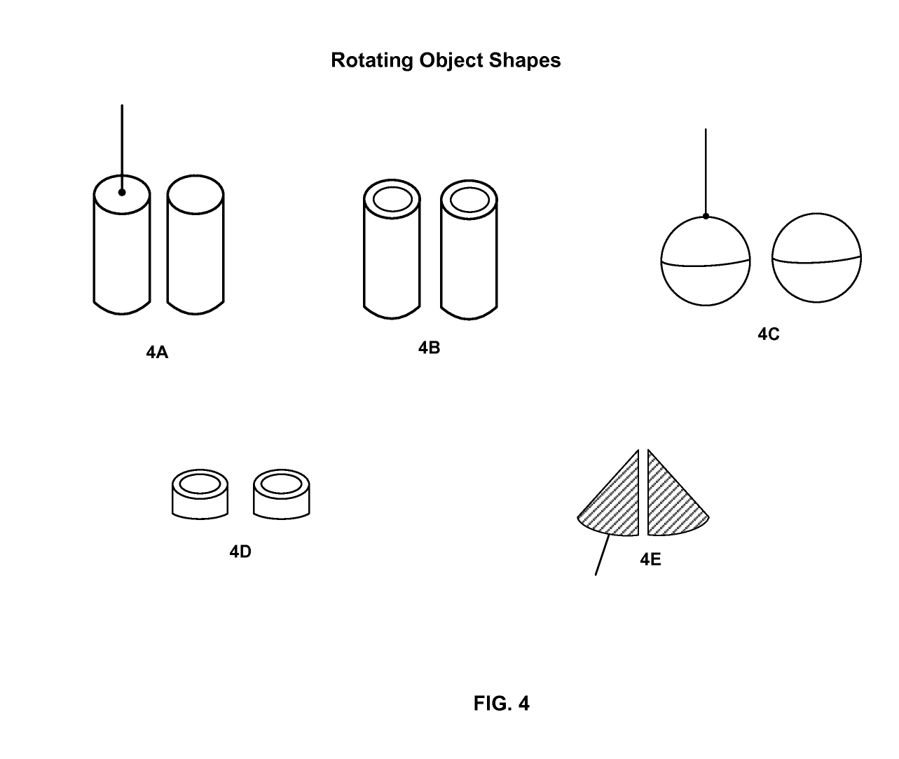

The rotating objects can be of different shapes and structures as illustrated in FIGS. 4A-E, depending on the design. In various embodiments, a rotating object for use in the present device can be hollow or solid, constructed of a single material or made from two or more materials, and may have an outer surface or coating of material that is different than a core material. The surface of material may be thick or thin, conducting or insulating, and the one or more core materials of construction within each of the rotating objects may be conductive or insulating as desired. Each rotating object comprises an outer surface material that necessarily contacts any other outer surface material of any other rotating object placed in contact thereby.

In various embodiments, first rotating object 101 comprises a first outer surface material having a dielectric constant of ∈₁, whereas second rotating object 102 comprises a second outer surface material having a dielectric constant of ∈₂. First outer surface material and second outer surface material are placed into constant frictional contact by moving the first rotating object 101 into contact with the second rotating object 102.

In one embodiment, rotating objects can be cylinders (FIGS. 4A and 4B). In addition, rotating objects could also be spheres (FIG. 4C). Different shapes can be used to vary the surface area of contact between rotating objects. For example, rotating cylinders in contact with one another will have a larger surface area of contact than rotating spheres placed into contact, although some variance in the area of contact is further expected depending on the hardness of the outer surface materials and the degree, if any, of deformation when the rotating objects are pushed together to achieve constant frictional contact.

Further, rotating objects can be rings of any height (FIG. 4D), which are similar to the cylindrical embodiment but having a hollow core. Moreover, rotating objects can also be right-circular cones (FIG. 4E), tilted relative to each other such that the lateral surfaces are in contact. In various embodiments, the first rotating object and the second rotating object can be of different shapes. For example, the first rotating object may be cylindrical whereas the second rotating object placed into frictional constant contact the first can be disc shaped.

The present disclosure is not limited to particular shapes for the rotating objects, or to any necessity that the rotating objects that are placed into frictional contact be of the same shape.

In various embodiments, the first rotating object comprises a first outer surface material, and the second rotating object comprises a second outer surface material. If made from a single material, the core of a rotating object will necessarily be the same as the outer surface material. In other embodiments, the core of a rotating object (e.g. a metal or insulating mandrel) may comprise a first material, and a second, different material may be used for the outer surface material around the mandrel, such as for example, a coating on the mandrel. The materials of the rotating objects, and in particular the Δ∈ between the outer surface materials in constant frictional contact, result in the generation of x-rays. Therefore, selection of the materials that will be in constant frictional contact is an important parameter in the amount of x-rays generated.

In selecting the outer surface materials for each of the rotating objects intended to be in constant frictional contact, one of the materials chosen can have a positive charging tendency whilst the other material chosen can have a negative charging tendency. A larger difference in charging tendencies between two materials results in a high electromagnetic radiation flux. As described earlier, a triboelectric series provides examples of various materials and their associated charging tendency. For example, acrylic and Corning's MACOR® may be used for the first and second rotating objects, respectively, when each is constructed of a single material, or these materials can be used as outer surface materials around a core. Furthermore, the rotating objects can utilize any material listed in a triboelectric series for at least the outer surface material of the rotating objects, and can comprise hydrocarbon, metal, polymer, glass, ceramic, natural materials, man-made materials, cloth, fiber, and paper, and any combination thereof.

In addition, the rotating objects can include matter in the form of solid, liquid, or gas. For example, a rotating object can have a solid outer shell and include a liquid-filled core, a gas-filled core, or a combination of liquid- and gas-filled core. The liquid-filled core can change the center of mass of the rotating object, which can be used to assist in generating x-rays by increasing the pressure at the point of friction between rotating objects. Furthermore, a liquid- and gas-filled core of a rotating object can change the inertia of the rotating object, which can also assist in generating x-rays.

Further, in various embodiments, one or more of the rotating objects can have an adhesive coating on the surface. For example, a first rotating object can have a surface that is dry and smooth, and that may contain metal or be entirely of metal. A second rotating object can be plastic or acrylic, or comprise a surface coated with an adhesive or resin. The interaction between the metal surface of the first rotating object and the plastic, acrylic or adhesive surface of the second rotating object increases the surface friction and generates a higher flux of x-ray radiation in comparison to rotating objects without adhesive. In accordance with various embodiments and by way of example, the adhesive coating can be a thermoplastic or a thermoset polymer adhesive. Thermoplastics include acrylics, asphalts, polyamides, polyvinyl acetates, EVA (ethylene vinyl acetate copolymer), PVC, and plastisols. Thermoset polymer adhesives include cyanoacrylates, PF, PRF (phenol resorcinol formaldehydes), epoxy, unsaturated/saturated polyesters, urea formaldehydes, and melamine formaldehydes.

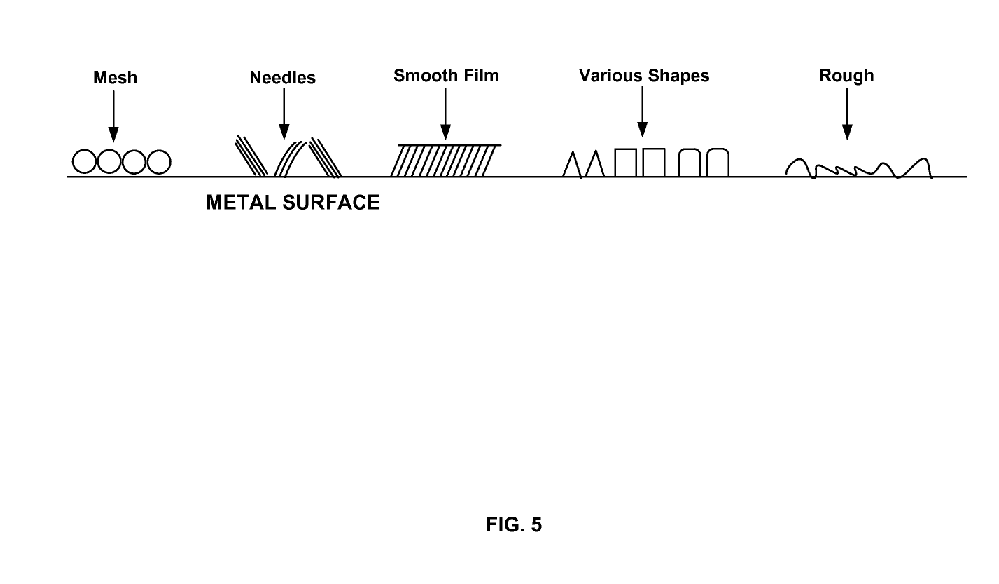

The outer surfaces of the rotating objects can have different shapes and textures at the molecular and/or microscopic level. In various embodiments, such as illustrated by FIG. 5, a rotating object's surface can be textured as a mesh, needles, smooth, rough, or geometric shapes such as pyramids, cubes, hemispheres, etc. In various embodiments, a pair of rotating objects placed into constant frictional contact may have complementary textures, for example protrusions on one surface and similarly sized divots on the other surface. Changing the surface area of a rotating object, such as from smooth to textured, changes the resulting EMR flux. The resulting EMR flux can be a combination of the amount surface area friction and the orbital interaction effect. In various embodiments, two surface areas in contact can each have the same or different geometric pattern, and any combination of the above mentioned geometric patterns can be implemented.

In accordance with various embodiments, the x-ray device can also comprise at least one belt that is partially looped around either the first rotating object or the second rotating object. The belt can be a continuous loop that cannot experience any rolling or unrolling during operation of the x-ray device. In various embodiments, a belt provides the outer surface material for one or both of the rotating objects. In various embodiments, the width of the belt is approximately equal to the height of the rotating objects in order to provide the most contact surface on the belt material. However, in other embodiments the width of the belt can be more or less than the height of the rotating objects. The belt material can be a woven material that is the same as the material comprising the opposite roller. In various embodiments, the belt can be made of a triboelectric material that is of the opposite triboelectric character compared to the rotating object being spun by the belt, or opposite in triboelectric character to the other rotating object in the pair. In some embodiments, either or both rotating objects in a pair of rotating objects acts as a drive shaft or mandrel to move one or more belts, whereby the constant frictional contact will be between a belt (driven by a pulley or mandrel) and a rotating object having a particular outer surface material, or between two belts, each driven by one or more pulleys or mandrels.

Additionally, in various embodiments, the belt can be made of a woven material, a polymer, leather, or any other suitable material. The belt material can then be coated on one or both sides with a different material, such as an adhesive or acrylic. Further, a different material can be layered on top of, or mixed into, the coating material. The materials layered on top of, or mixed into, the coating material can be any triboelectric material. In some embodiments, the x-ray device can be belt driven in place of the drive shaft. In devices having multiple rotating objects being belt driven, it can be beneficial to operate a belt having a first triboelectric material on a first side of the belt, and a second triboelectric material on a second side of the belt. The first and second triboelectric materials can be of opposite triboelectric character.

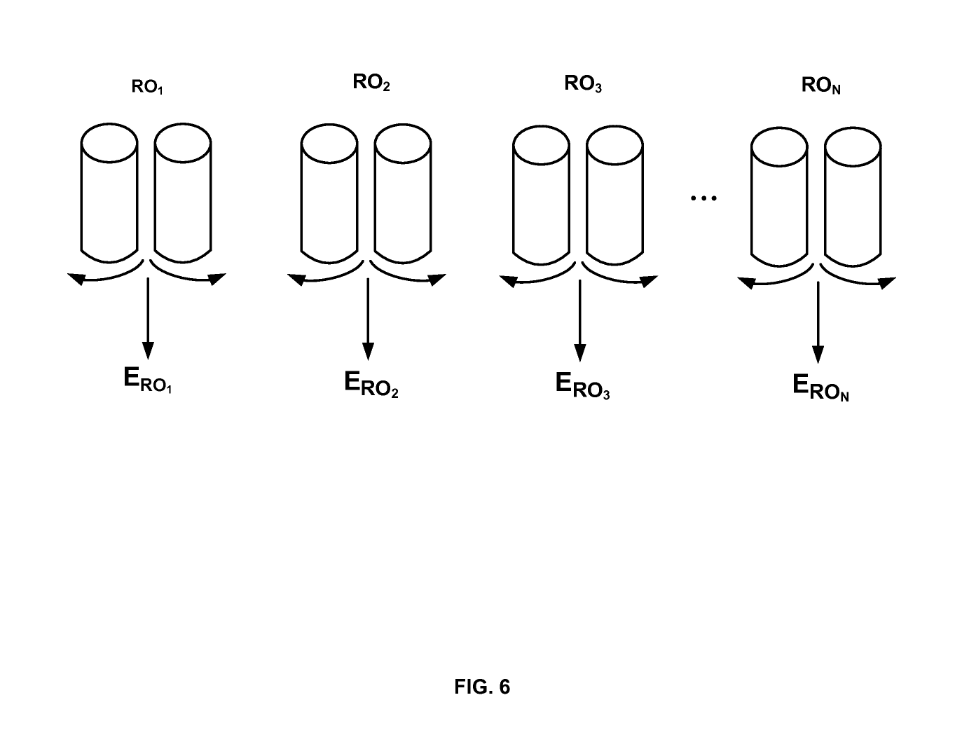

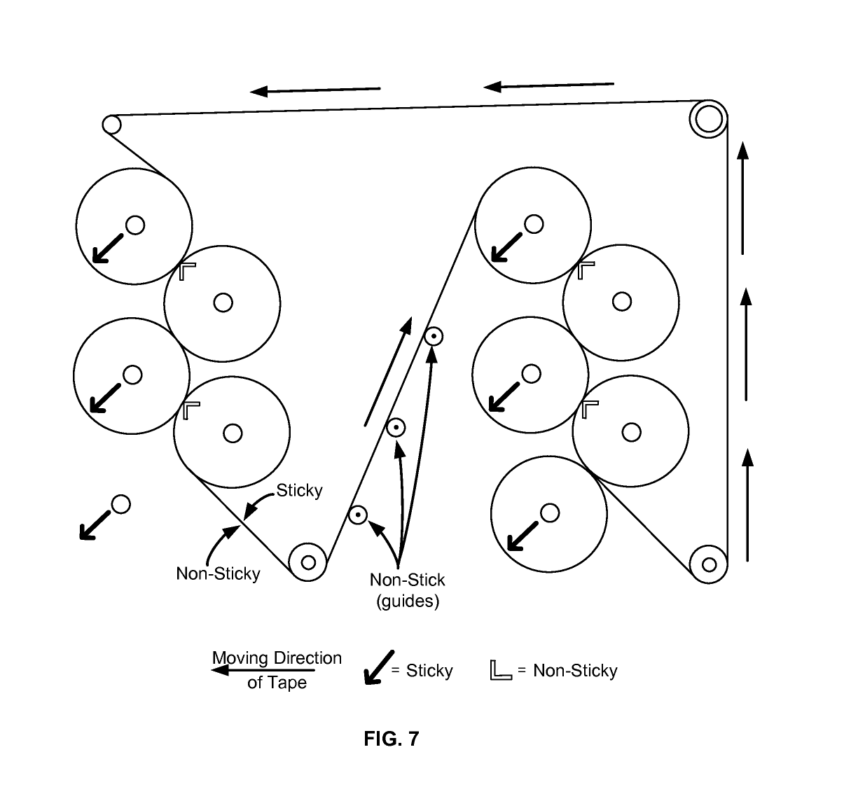

As briefly mentioned above, in various embodiments the x-ray device can comprise multiple rotating objects, referring to three or more rotating objects. Such embodiments can include multiple pairs of rotating objects, each pair generating flux as illustrated in FIG. 6. Or such embodiments can include multiple rotating objects being rotated by a belt and not in contact with another rotating object. One embodiment of an x-ray device having multiple rotating object pairs, for example RO₁, RO₂, RO₃ . . . RO_{N} is illustrated in FIG. 7. In a multiple rotating object embodiment, each rotating object contributes its own flux (E_{RO1}, E_{RO2}, E_{RO3} . . . E_{RON}, and the total flux generated by the device is the sum of the flux from each pair of rotating objects (E_{TOTAL}=Σ_{RO1}, E_{RO2}, E_{RO3}, . . . E_{RON}). In various embodiments, device configuration alternates the sticky and non-sticky rotating objects to increase energy input to flux efficiency. The flux efficiency can be increased based in part on the EMR outputs projecting in the same direction.

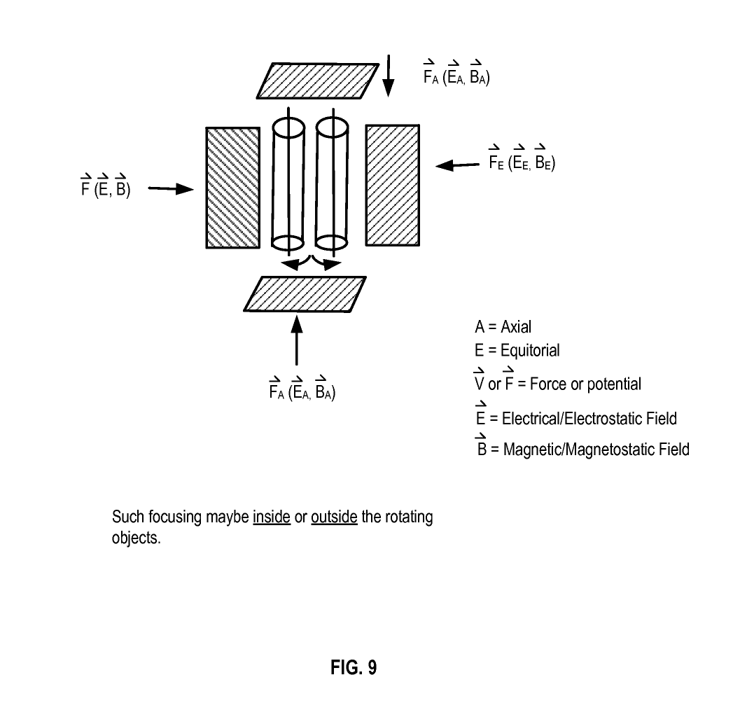

Furthermore, in various embodiments having multiple rotating objects, the generated electromagnetic radiation fluxes can be optically focused into a collimated x-ray. The focusing may be accomplished by either electron focusing by electric or magnetic fields or x-ray optics such as lens, crystals, gratings, and the like. In accordance with various embodiments, and with reference to FIG. 9, x-ray radiation generated by the friction between rotating objects in contact can be electromagnetically focused. In various embodiments, only one or more of the illustrated forces can be applied for electron focusing. In other words, electromagnetic forces can be applied on opposite sides of the rotating objects for electron focusing, or electromagnetic forces can be applied on all sides of the rotating objects. The electromagnetic forces can be applied at the rotating objects or can be applied below the rotating objects on the x-rays.

In combination with any of the embodiments described above, an x-ray device can also include self-vacuuming functionality. The self-vacuuming functionality can be provided by an x-ray device further comprising a vacuum pump. Moreover, in various embodiments, an x-ray device can comprise removable rotating objects. For example, the rotating objects can be in a cartridge and removable and replaceable. The different cartridges can contain rotating objects with different sizes, materials, shapes, and the like. In this manner, various cartridges can be available for different uses depending on the application. Some applications may use a higher flux than others, and so an appropriate cartridge (and corresponding rotating objects) can be selected and inserted into the x-ray device.

In various embodiments, the present disclosure also encompasses a method of generating x-ray radiation. In various embodiments, the method comprises: positioning a first rotating object and a second rotating object in constant frictional contact wherein x-rays are generated in response to the rotation of the first and second rotating objects.

In various embodiments, the method further comprises mechanical rotation of one rotating object and the passive rotation of the second rotating object due to the constant contact with the mechanically rotated object. In other embodiments, both rotating objects are mechanically rotated, in opposite directions, with motors or other means.

In various embodiments of the method, the first rotating object and the second rotating object have opposite triboelectric character. In various embodiments of the method, the first rotating object comprises a material having a RDP of ∈₁, the second rotating object comprises a material having a RDP of ∈₂, and ∈₁ does not equal ∈₂. In various embodiments of the method, the difference between ∈₁ and ∈₂ is maximized.

In various embodiments of the method, the first rotating object comprises a first outer surface material having a RDP of ∈₁, the second rotating object comprises a second outer surface material having a RDP of ∈₂, and ∈₁ does not equal ∈₂. In various embodiments of the method, the difference between ∈₁ and ∈₂ is maximized.

The present invention has been described above with reference to various exemplary embodiments. However, those skilled in the art will recognize that changes and modifications may be made to the exemplary embodiments without departing from the scope of the present invention. For example, the various exemplary embodiments can be implemented with other types of power supply circuits in addition to the circuits illustrated above. These alternatives can be suitably selected depending upon the particular application or in consideration of any number of factors associated with the operation of the system. Moreover, these and other changes or modifications are intended to be included within the scope of the present invention, as expressed in the following claims.

What is claimed is:

1. An x-ray generating device comprising:
a first rotating object having a first outer surface material; and
a second rotating object having a second outer surface material,
wherein said first and second rotating objects are disposed in proximity to one another such that said first and second outer surface materials remain in constant frictional contact during rotation of said objects; and
wherein x-ray radiation is generated in response to rotation of said objects.

2. The x-ray device of claim 1, wherein said first outer surface material has a RDP of ∈₁, said second outer surface material has a RDP of ∈₂, wherein ∈₁ does not equal ∈₂.

3. The x-ray device of claim 2, wherein the difference between the values of ∈₁ and ∈₂ is maximized through selection of the first and second outer surface materials.

4. The x-ray device of claim 1, further comprising a housing enclosing both first and second rotating objects, creating a controllable environment.

5. The x-ray device of claim 4, wherein said environment comprises a vacuum from below room pressure to 10⁻⁶ torr.

6. The x-ray device of claim 1, wherein said first and second outer surface materials are selected from the group consisting of hydrocarbon, metal, polymer, glass, ceramic, natural materials, man-made materials, cloth, fiber, paper, and mixtures thereof.

7. The x-ray device of claim 1, further comprising at least one motor connected to at least one drive shaft, both configured to mechanically rotate at least one of said first and second rotating objects.

8. The x-ray device of claim 1, wherein one of said first and second outer surface materials comprises a continuous belt looped around either said first or second rotating object.

9. The x-ray device of claim 1, wherein at least one of said first and second rotating objects comprises a central core constructed of material different from said outer surface material.

10. A method of generating x-ray radiation, the method comprising:
positioning a first rotating object and a second rotating object in constant frictional contact; and
rotating the first rotating object in a first direction and the second rotating object in a second, opposite direction,
wherein x-rays are generated in response to the rotating of the first and second rotating objects.

11. The method of claim 10, wherein said first rotating object comprises a first triboelectric material, and said second rotating object comprises a second triboelectric material having an opposite triboelectric character as the first triboelectric material, and wherein said first and second triboelectric materials are in constant frictional contact during said rotation of said rotating objects.

12. The method of claim 11, wherein the difference between said triboelectric characters is maximized.

13. The method of claim 10, wherein said first and second rotating objects are constructed of materials selected from the group consisting of hydrocarbon, metal, polymer, glass, ceramic, natural materials, man-made materials, cloth, fiber, paper, and mixtures thereof.

14. The method of claim 10, wherein said first rotating object further comprises a first outer surface material having a RDP of ∈₁, said second rotating object further comprises a second outer surface material having a RDP of ∈₂, and wherein ∈₁ does not equal ∈₂.

15. The method of claim 14, wherein the difference between ∈₁ and ∈₂ is maximized.

16. An x-ray device comprising:
a first rotating object having a first material, wherein the first rotating object has a center axis oriented in a first direction;
a second rotating object having a second material, wherein the second rotating object has a center axis oriented in the first direction;
wherein the first rotating object and the second rotating object are inside a housing, and wherein the housing has a vacuum environment;
wherein the first rotating object and the second rotating object are positioned within the housing such that an outer edge of the first rotating object is in contact with an outer edge of the second rotating object; and
wherein the first rotating object is rotated in a first direction and causes the second rotating object to rotate in an opposite direction of the first direction, and wherein radiation energy is generated in response to the rotating of the first and second rotating objects.
